(19) United States
(12) Patent Application Publication
(10) Pub. No.: US 2026/0104838 A1
(43) Pub. Date: Apr. 16, 2026

(54) ELECTRONIC APPARATUS FOR PROVIDING GUIDANCE MESSAGE BASED ON TYPE OF CABLE AND CONTROL METHOD THEREOF

(71) Applicant: SAMSUNG ELECTRONICS CO., LTD., Suwon-si (KR)

(72) Inventors: Yongsoo CHOI, Suwon-si (KR); Jeongkee Park, Suwon-si (KR); Eungyeong Go, Suwon-si (KR); Jungkeun Kim, Suwon-si (KR); Euihyung Yoo, Suwon-si (KR); Seulbi Lee, Suwon-si (KR)

(73) Assignee: SAMSUNG ELECTRONICS CO., LTD., Suwon-si (KR)

(21) Appl. No.: 19/308,842

(22) Filed: Aug. 25, 2025

Related U.S. Application Data
(63) Continuation of application No. PCT/KR2025/010489, filed on Jul. 16, 2025.

(30) Foreign Application Priority Data
Oct. 11, 2024 (KR) 10-2024-0138410

(51) Int. Cl. G06F 3/147

(52) U.S. Cl. CPC G06F 3/147

(57) ABSTRACT

An electronic apparatus may include a memory storing instructions, a communication interface, and at least one processor including processing circuitry. When individually or collectively executed by the at least one processor, the instructions cause the at least one processor to, based on a video interface cable being connected to the communication interface, identify a communication standard supported by the video interface cable based on a voltage applied to a configuration pin included in the communication interface, and provide a guidance message based on the communication standard and display capability information of the electronic apparatus.

### CROSS-REFERENCE TO RELATED APPLICATION

This application is a continuation of PCT/KR2025/010489, filed on Jul. 16, 2025, at the Korean Intellectual Property Receiving Office and claims priority under 35 U.S.C. § 119 to Korean Patent Application No. 10-2024-0138410, filed on Oct. 11, 2024, in the Korean Intellectual Property Office, the disclosure of which is incorporated by reference herein in its entirety.

### BACKGROUND

### 1. Field

The present disclosure relates to an electronic apparatus and a control method thereof, and more particularly, to an electronic apparatus for providing a guidance message based on a type of cable, and a control method thereof.

### 2. Description of Related Art

A cable may be an important element that connects a source device (e.g., a personal computer (PC) or a game console) to a sink device (e.g., a monitor or signage). Through the cable, a data signal may be transmitted and an image may be output from the sink device.

Types of cable may include video graphics array (VGA), digital visual interface (DVI), high definition multimedia interface (HDMI), DisplayPort (DP), or the like, and each type of cable may support different transmission speeds and resolutions. For example, the VGA cable supports the most basic resolution and color in an analog manner, while the HDMI cable or the DisplayPort cable may support a high resolution of 4K or higher and a wide color region in a digital manner. Therefore, an appropriate cable needs to be selected based on the performance of the source device or the sink device. In addition, if the cable is too long, signal loss may occur, and a cable having an appropriate length therefore needs to be selected.

If the source device and the sink device are connected to each other by using a high-performance digital interface cable such as DisplayPort cable, the user is unable to determine whether an appropriate version of cable is used. Accordingly, a screen may be displayed while having a resolution and a refresh rate that do not match the performance of the source device or the sink device. For example, the use of a DisplayPort 1.2 or 1.4 cable may prevent the display of ultra-high-resolution content such as 7680×2160@240 Hz, potentially resulting in screen artifacts or signal noise.

### SUMMARY

According to an embodiment of the present disclosure, provided is an electronic apparatus including: a memory storing instructions; a communication interface; and at least one processor including processing circuitry, wherein if individually or collectively executed by the at least one processor, the instructions cause the at least one processor to: based on a video interface cable being connected to the communication interface, identify a communication standard supported by the video interface cable based on a voltage applied to a configuration pin included in the communication interface, and provide a guidance message based on the communication standard and display capability information of the electronic apparatus.

The apparatus may further include a display, wherein when individually or collectively executed by the at least one processor, the instructions cause the at least one processor to control the display to display the guidance message based on the communication standard and display capability information of the display.

When individually or collectively executed by the at least one processor, the instructions may cause the at least one processor to control the display to display a first guidance message if a first bandwidth supported by the communication standard is greater than or equal to a second bandwidth supported by the display, and control the display to display a second guidance message if the first bandwidth is less than the second bandwidth.

The first guidance message may include display state information of the display, and the second guidance message may suggest a replacement of the video interface cable.

When individually or collectively executed by the at least one processor, the instructions may cause the at least one processor to control the display to display the first guidance message and the second guidance message at different positions.

When individually or collectively executed by the at least one processor, the instructions may cause the at least one processor to reset at least one of extended display identification data (EDID) or DisplayPort configuration data (DPCD) of the display based on the video interface cable.

When individually or collectively executed by the at least one processor, the instructions may cause the at least one processor to control the communication interface to transmit the guidance message to a user terminal device if a first bandwidth supported by the communication standard is less than a second bandwidth supported by the display.

The display capability information of the display may include at least one of a bandwidth or a resolution of the display.

The apparatus may further include a user interface, wherein when individually or collectively executed by the at least one processor, the instructions causes the at least one processor to control the display to display the guidance message based on the communication standard and changed performance information of the display if a user command for changing at least one of the bandwidth or resolution of the display is received.

When individually or collectively executed by the at least one processor, the instructions may cause the at least one processor to: based on the voltage applied to the configuration pin being 0V, identify the video interface cable as conforming to a first communication standard, based on the voltage applied to the configuration pin exceeding 0V and being within a first voltage range, identify the video interface cable as conforming to a second communication standard, and based on the voltage applied to the configuration pin exceeding 0V and being within a second voltage range greater than the first voltage range, identify the video interface cable as conforming to a third communication standard.

The apparatus may further include a speaker, wherein when individually or collectively executed by the at least one processor, the instructions cause the at least one processor to output the guidance message through the speaker based on the communication standard and the display capability information of the electronic apparatus.

According to an embodiment of the present disclosure, provided is control method of an electronic apparatus, the method including: based on a video interface cable being connected to a communication interface: identifying a communication standard supported by the video interface cable based on a voltage applied to a configuration pin included in the communication interface of the electronic apparatus; and providing a guidance message based on the communication standard and display capability information of the electronic apparatus.

In the providing of the guidance message, the guidance message may be displayed based on the communication standard and display capability information of a display included in the electronic apparatus.

In the providing of the guidance message, a first guidance message may be displayed if a first bandwidth supported by the communication standard is greater than or equal to a second bandwidth supported by the display, and a second guidance message may be displayed if the first bandwidth is less than the second bandwidth.

The first guidance message may include display state information of the display, and the second guidance message may suggest a replacement of the video interface cable.

In the providing of the guidance message, the first guidance message and the second guidance message may be displayed at different positions.

The method may further include resetting at least one of the extended display identification data (EDID) or DisplayPort configuration data (DPCD) of the display based on the cable.

The method may further include transmitting the guidance message to a user terminal device if a first bandwidth supported by the communication standard is less than a second bandwidth supported by the display.

The display capability information of the display may include at least one of the bandwidth or resolution of the display.

The method may further include displaying the guidance message based on the communication standard and changed performance information of the display if a user command for changing at least one of the bandwidth or resolution of the display is received.

In the identifying of the communication standard, the cable may be identified as a cable conforming to a first communication standard if the voltage applied to the first pin is 0 V, the cable may be identified as a cable conforming to a second communication standard if the voltage applied to the first pin exceeds 0 V and falls within a first voltage range, and the cable may be identified as a cable conforming to a third communication standard if the voltage applied to the first pin exceeds 0 V and falls within a second voltage range greater than the first voltage range.

In the providing of the guidance message, the guidance message may be output through the speaker included in the electronic apparatus based on the communication standard and the performance information of the electronic apparatus.

According to an embodiment of the present disclosure, there is provided a non-transitory computer-readable storage medium storing instructions that, when executed by one or more processors, cause the one or more processor to perform: based on a video interface cable being connected between a source device and a sink device through a communication interface, identifying a communication standard supported by the video interface cable based on a voltage applied to a configuration pin in the communication interface; and providing a guidance message based on the identified communication standard and display capability information of the sink device.

### BRIEF DESCRIPTION OF DRAWINGS

FIG. 1 is a block diagram showing a configuration of an electronic apparatus according to an embodiment of the present disclosure.

FIG. 2 is a block diagram showing a detailed configuration of the electronic apparatus according to an embodiment of the present disclosure.

FIG. 3 is a diagram for describing a structure of a cable according to an embodiment of the present disclosure.

FIGS. 4 and 5 are diagrams for respectively describing the communication standard supported by the cable and performance information of a display according to an embodiment of the present disclosure.

FIGS. 6 to 9 are diagrams for respectively describing a method for providing a guidance message according to an embodiment of the present disclosure.

FIG. 10 is a flowchart for describing a control method of an electronic apparatus according to an embodiment of the present disclosure.

### DETAILED DESCRIPTION

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

The present disclosure relates to an electronic apparatus and a control method thereof, which provides a guidance message based on a version and/or a type of a video interface cable (e.g., DisplayPort, Video Graphics Array (VGA), Digital Visual Interface (DVI), or High-Definition Multimedia Interface (HDMI)) connected between a source device and a sink device.

Hereinafter, the embodiments of the present disclosure are described in detail with reference to the accompanying drawings.

General terms that are currently widely used are selected as terms used in embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, an expression “have”, “may have”, “include”, “may include” or the like, indicates existence of a corresponding feature (for example, a numerical value, a function, an operation or a component such as a part), and does not exclude existence of an additional feature.

An expression, “at least one of A or/and B” may indicate either “A or B”, or “both of A and B.”

Expressions “first,” “second,” and the like, used in the present disclosure may indicate various components regardless of the sequence or importance of the components. The expression is used only to distinguish one component from another component, and does not limit the corresponding component.

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the specification, such a term as a “user” may refer to a person who uses the electronic apparatus or an apparatus (for example, an artificial intelligence electronic apparatus) which uses the electronic apparatus.

The term “an embodiment” is not intended to refer to a single embodiment exclusively, but rather may encompass one or more embodiments.

Hereinafter, various embodiments of the present disclosure are described in detail with reference to the accompanying drawings.

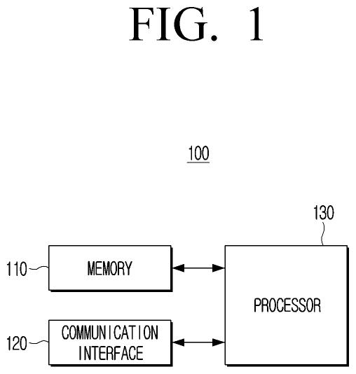

FIG. 1 is a block diagram showing a configuration of an electronic apparatus 100 according to an embodiment of the present disclosure.

The electronic apparatus 100 may be a device for displaying an image, or may refer to a device including a display, such as a television (TV), a desktop personal computer (PC), a laptop, a smartphone, or a tablet PC, and may be referred to as a sink device. Here, the electronic apparatus 100 may be connected to another electronic apparatus, referred to as the source device, through a cable (e.g., a video interface cable) and may receive an image from another electronic apparatus. However, the electronic apparatus 100 is not limited thereto, and may include any device capable of displaying an image. In addition, the electronic apparatus 100 may be implemented as a device for receiving an image from another electronic apparatus, processing the received image, and providing the processed image to a display device.

As shown in FIG. 1, the electronic apparatus 100 may include a memory 110, a communication interface 120, and a processor 130.

The memory 110 may refer to hardware that stores information such as data in an electrical or magnetic form to enable the processor 130 or the like to access the memory 110. To this end, the memory 110 may be implemented as at least one hardware component among a non-volatile memory, a volatile memory, a flash memory, a hard disk drive (HDD), a solid state drive (SSD), a random access memory (RAM), a read only memory (ROM), or the like.

The memory 110 may store at least one instruction required for an operation of the electronic apparatus 100 or the processor 130. Here, the instruction refers to a code unit for instructing the operation of the electronic apparatus 100 or the processor 130, and may be recorded in machine language, which is a language understandable by a computer.

The memory 110 may store data, which is information in bit or byte units that may represent characters, numbers, images, or the like. For example, the memory 110 may store information on a method for operating the electronic apparatus 100. The memory 110 may store the extended display identification data (EDID) or DisplayPort configuration data (DPCD) of a display included in the electronic apparatus 100.

The memory 110 may be accessed by the processor 130, and instructions, instruction sets, or data may be read, written, modified, deleted, updated, or the like by the processor 130.

The communication interface 120 is a component for performing communication with various types of external devices by using various types of communication methods. For example, the electronic apparatus 100 may communicate with another electronic apparatus through the communication interface 120.

The communication interface 120 may include a wireless-fidelity (Wi-Fi) module, a Bluetooth module, an infrared communication module, a wireless communication module, or the like. Here, each communication module may be implemented in the form of at least one hardware chip.

The Wi-Fi module and Bluetooth module may perform the communication in a Wi-Fi manner and a Bluetooth manner, respectively. In case of using the Wi-Fi module or Bluetooth module, the communication interface 120 may first transmit and receive various connection information such as a service set identifier (SSID) or a session key, and connect the communication based on this connection information, and then transmit and receive various information. The infrared communication module may perform the communication based on infrared data association (IrDA) technology that wirelessly transmits data in a short distance using an infrared ray between visible spectrum and millimeter waves.

In addition to the above-described communication manners, the wireless communication module may include at least one communication chip performing the communication based on various wireless communication standards such as Zigbee, third generation (3G), 3rd generation partnership project (3GPP), long term evolution (LTE), LTE advanced (LTE-A), 4th generation (4G), and 5th generation (5G).

The communication interface 120 may include a wired communication interface (e.g., a wired video communication interface) such as a high definition multimedia interface (HDMI), DisplayPort, Thunderbolt, a universal serial bus (USB), a red-green-blue (RGB) port, a D-subminiature (D-SUB) port, or a digital visual interface (DVI) port.

In addition, the communication interface 120 may also include at least one of wired communication modules performing the communication by using a local area network (LAN) module, an Ethernet module, a pair cable, a coaxial cable, or an optical fiber cable.

The processor 130 may control overall operations of the display device 100. In detail, the processor 130 may be connected to each component of the display device 100 and control the overall operations of the display device 100. For example, the processor 130 may be connected to components such as the memory 110, the communication interface 120, or the like to control the operation of the electronic apparatus 100.

At least one processor may include of a central processing unit (CPU), a graphic processing unit (GPU), an accelerated processing unit (APU), a many integrated core (MIC), a neural processing unit (NPU), a hardware accelerator, or a machine learning accelerator. At least one processor may control one or any combination of other components included in the electronic apparatus 100, and may perform operations related to communication or data processing. At least one processor may execute at least one program or instruction stored in the memory 110. For example, at least one processor may perform a method according to an embodiment of the present disclosure by executing at least one instruction stored in the memory 110.

If the method according to an embodiment of the present disclosure includes a plurality of operations, the plurality of operations may be performed by a single processor, or may be performed by a plurality of processors. For example, if a first operation, a second operation, and a third operation are performed by the method according to an embodiment, the first operation, the second operation, and the third operation may all be performed by a first processor. Alternatively, the first operation and the second operation may be performed by the first processor (for example, a general-purpose processor), and the third operation may be performed by a second processor (for example, an artificial intelligence-only processor).

At least one processor may be implemented as a single-core processor including a single core, or may be implemented as at least one multi-core processor including multi-cores (for example, homogeneous multi-cores or heterogeneous multi-cores). If at least one processor is implemented as the multi-core processor, each of the multi-cores included in the multi-core processor may include a processor internal memory such as a cache memory or an on-chip memory, and a common cache shared by the multi-cores may be included in the multi-core processor. In addition, each (or some) of the multi-cores included in the multi-core processor may independently read and perform a program instruction for implementing the method according to an embodiment of the present disclosure, or all (or some) of the multi-cores may be linked with each other to read and perform the program instruction for implementing the method according to an embodiment of the present disclosure.

If the method according to an embodiment of the present disclosure includes the plurality of operations, the plurality of operations may be performed by the single core among the multi-cores included in the multi-core processor, or may be performed by the multi-cores. For example, if the first operation, the second operation, and the third operation are performed using the method according to an embodiment, the first operation, the second operation, and the third operation may all be performed by a first core included in the multi-core processor. Alternatively, the first operation and the second operation may be performed by the first core included in the multi-core processor, and the third operation may be performed by a second core included in the multi-core processor.

In the embodiments of the present disclosure, at least one processor may be part of a system-on-chip (SoC) in which at least one processor and other electronic components are integrated with each other, the single-core processor, the multi-core processor, or the core included in the single-core processor or the multi-core processor. Here, the core may be implemented as the CPU, the GPU, the APU, the MIC, the NPU, the hardware accelerator, the machine learning accelerator, or the like. However, the embodiments of the present disclosure are not limited thereto. However, for convenience of description, the operation of the electronic apparatus 100 is described below using the expression “processor 130.”

The processor 130 may identify a communication standard supported by the cable based on a voltage applied to a first pin (e.g., a configuration pin) included in the communication interface 120 if the cable is connected to the communication interface 120. Here, the communication standard may include a transmission standard, the transmission specification, a transmission method, a transmission speed, a transmission type, or the like. The transmission standard may refer to an overarching protocol or specification governing a data transmission format and behavior, such as DisplayPort 1.2, DisplayPort 2.1, HDMI 2.1, or USB4. The transmission specification may refer to detailed electrical and logical parameters defined within a transmission standard, including voltage levels, impedance, timing requirements, lane count, symbol encoding (e.g., 8b/10b, 128b/132b), and packet structure. The transmission method may refer to a mode or technique by which data is transferred across the cable, such as packet-based transmission, continuous streaming, or burst transmission. The transmission speed may refer to a data rate at which data is transmitted, which may be measured in gigabits per second (Gbps) per lane or aggregate throughput. For example, DisplayPort 1.2 supports up to 5.4 Gbps per lane (HBR2), whereas DisplayPort 2.1 supports up to 20 Gbps per lane (UHBR20). The transmission type may refer to an electrical signaling mechanism used to transmit data, such as differential signaling (e.g., used in DisplayPort and USB for noise immunity) or single-ended signaling (used in some legacy or low-speed interfaces).

For example, the processor 130 may identify the cable as conforming to a first communication standard if the voltage applied to the first pin is a zero (0) voltage. The processor 130 may identify the cable as conforming to a second communication standard if the voltage applied to the first pin exceeds 0 V and falls within a first voltage range. The processor 130 may identify the cable as conforming to a third communication standard if the voltage applied to the first pin exceeds 0 V and falls within a second voltage range greater than the first voltage range. For example, the cable conforming to the first communication standard may be a cable supporting DisplayPort 1.2 or 1.4, the cable conforming to the second communication standard may be a cable supporting DisplayPort 2.1 DP 54, and the cable conforming to the third communication standard may be a cable supporting DisplayPort 2.1 DP 80.

The cable supporting DisplayPort 1.2 or 1.4 may not include a resistor between a CONFIG1 pin and a CONFIG2 pin corresponding to pins 13 and 14, respectively. The cable supporting DisplayPort 2.1 DP 54 may include a 680 kohm resistor between the CONFIG1 pin and the CONFIG2 pin, and the cable supporting DisplayPort 2.1 DP 80 may include a 220 kohm resistor between the CONFIG1 pin and the CONFIG2 pin. According to an embodiment, the processor 130 may identify a voltage on the CONFIG2 pin, identify the cable as supporting DisplayPort 1.2 or 1.4 if the identified voltage is 0 V, identify the cable as supporting DisplayPort 2.1 DP 54 if the identified voltage is between 0.33 V and 0.50 V, and identify the cable as supporting DisplayPort 2.1 DP 80 if the identified voltage is between 0.86 V and 1.20 V. However, the processor 130 is not limited thereto, and may also identify the cable as supporting DisplayPort 1.2, 1.4 or a lower specification if the identified voltage is 0 V.

The processor 130 may provide a guidance message based on the communication standard and performance information of the electronic apparatus 100. For example, the processor 130 may control the display to display the guidance message based on the communication standard and performance information of the display included in the electronic apparatus 100. Here, the performance information of the electronic apparatus 100 may refer to various hardware or system-level limitations that affect data transmission or display capabilities. In the present disclosure, the performance information may be also referred to as display capability information. For example, the performance information of the electronic apparatus 100 may include at least one of a maximum bandwidth (e.g., the highest data transfer rate the electronic apparatus 100 is capable of handling over a selected video communication interface, such as 17.28 Gbps for DisplayPort 1.4 or 80 Gbps for DisplayPort 2.1), maximum resolution (e.g., the highest video resolution by the display, such as 3840×2160 (4K) at 60 Hz, or 7680×4320 (8K) at 30 Hz) of the display included in the electronic apparatus 100.

In an embodiment, the processor 130 may control the display to display a first guidance message if a first bandwidth supported by the communication standard is greater than or equal to a second bandwidth supported by the display, and may control the display to display a second guidance message if the first bandwidth is less than the second bandwidth. Here, the first guidance message may include display state information of the display, and the second guidance message may be a guidance message indicating that the cable needs to be replaced.

The processor 130 may control the display to display the first guidance message and the second guidance message at different positions. For example, the processor 130 may control the display to display the first guidance message at an upper right side of the display and the second guidance message at the center of the display. However, the processor 130 is not limited thereto, and may control the display to differently display at least one of the font size or font color of the first guidance message or that of the second guidance message. Alternatively, the processor 130 may display only the second guidance message instead of displaying the first guidance message.

The processor 130 may reset at least one of the extended display identification data (EDID) or DisplayPort configuration data (DPCD) of the display based on the cable. For example, the processor 130 may replace the EDID and the DPCD, stored in the memory 110, with the EDID and the DPCD corresponding to the communication standard supported by the cable, respectively. In addition, the processor 130 may change the DisplayPort version of an on-screen display (OSD) menu to 2.1 and set the EDID and the DPCD corresponding to DisplayPort 2.1 if the cable is identified as supporting DisplayPort 2.1 DP 80. Here, the EDID and the DPCD may be provided to another electronic apparatus through the communication interface 120 based on a connection of the cable. Another electronic apparatus may be a device connected to the electronic apparatus 100 through the cable.

The processor 130 may control the communication interface 120 to transmit the guidance message to a user terminal device if the first bandwidth supported by the communication standard is less than the second bandwidth supported by the display. The processor 130 may output the guidance message through a speaker included in the electronic apparatus 100 based on the communication standard and the performance information of the electronic apparatus 100.

Meanwhile, the performance information of the display is described above in terms of bandwidth, and is not limited thereto. For example, the performance information of the display may include at least one of the bandwidth or resolution of the display. For example, the processor 130 may control the display to display the guidance message based on the communication standard and the resolution of the display included in the electronic apparatus 100.

In an embodiment, the processor 130 may control the display to display the first guidance message if a first resolution supported by the communication standard is greater than or equal to a second resolution supported by the display, and may control the display to display the second guidance message if the first resolution is less than the second resolution. Here, the first guidance message may include the display state information of the display, and the second guidance message may include the guidance message indicating that the cable needs to be replaced.

Meanwhile, the performance information of the electronic apparatus 100 is described above as the performance information of the display, but is not limited thereto. For example, the performance information of the electronic apparatus 100 may include performance information of a graphic processing unit included in the electronic apparatus 100. For example, the processor 130 may control the display to display the guidance message based on the communication standard and at least one of the processing bandwidth or processing resolution of the graphic processing unit included in the electronic apparatus 100.

Meanwhile, the performance information of the electronic apparatus 100 is described above as performance limitation information that may be output by the electronic apparatus 100, and is not limited thereto. For example, the electronic apparatus 100 may further include a user interface, and the processor 130 may control the display to display the guidance message based on the communication standard and changed performance information of the display if a user command for changing at least one of the bandwidth or resolution of the display is received.

In a display device (e.g., a sink device) according to one or more embodiments, when a connection is established with a source device via a video interface cable (e.g., a DisplayPort cable), the display device may detect a voltage level on a designated pin of the video interface (e.g., the CONFIG pin). This voltage is used by the display device to automatically determine whether the connected cable supports a specific digital display interface standard, such as the latest high-bandwidth standard (e.g., DisplayPort 2.1) and its associated maximum data rate. Based on this determination, the display device may provide real-time feedback to the user via an On-Screen Display (OSD). This feedback allows the user to visually verify the compatibility and performance characteristics of the connected video interface cable, such as bandwidth support and standard compliance, without the need for external diagnostic tools or software utilities.

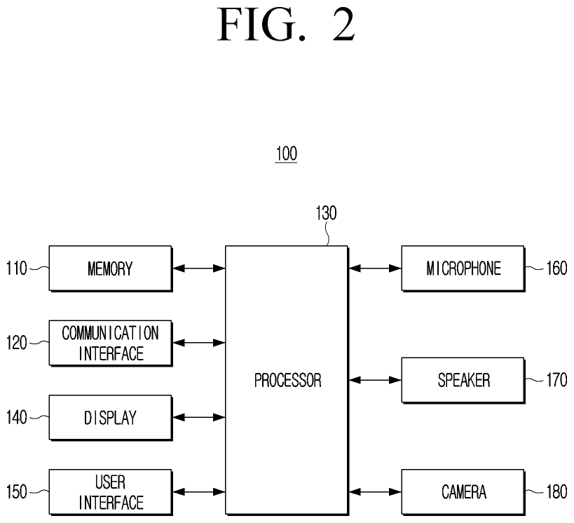

FIG. 2 is a block diagram showing a detailed configuration of the electronic apparatus 100 according to an embodiment of the present disclosure. The electronic apparatus 100 may include the memory 110, the communication interface 120, and the processor 130. In addition, referring to FIG. 2, the electronic apparatus 100 may further include a display 140, a user interface 150, a microphone 160, a speaker 170, and a camera 180. Detailed descriptions of the components shown in FIG. 2 that overlap with the components shown in FIG. 1 are omitted.

The display 140 may display an image and may be implemented as any of various types of displays such as a liquid crystal display (LCD), an organic light emitting diode (OLED) display, or a plasma display panel (PDP). The display 140 may also include a driving circuit, a backlight unit, and the like, which may be implemented in a form such as an amorphous silicon thin-film transistor (a-si TFT), a low-temperature polycrystalline silicon (LTPS) TFT, or an organic TFT (OTFT). Meanwhile, the display 140 may be implemented as a touchscreen coupled with a touch sensor, a flexible display, a three-dimensional (3D) display, or the like.

The processor 130 may control the display 140 to display an image.

The user interface 150 may be implemented, for example, as a button, a touch pad, a mouse, or a keyboard, or may also be implemented as a touchscreen capable of performing both display and manipulation input functions. Here, the button may be any of various types of buttons, such as a mechanical button, a touch pad, or a wheel, and may be disposed on any portion of a body appearance of the electronic apparatus 100, such as a front surface, a side surface, or a rear surface.

The microphone 160 may receive sound and convert the same into an audio signal. The microphone 160 may be electrically connected to the processor 130 and may receive sound under control of the processor 130.

For example, the microphone 160 may be implemented as an integrated unit integrated with the upper portion, front portion, side portion, or the like of the electronic apparatus 100. Alternatively, the microphone 160 may be disposed on a remote control that is separate from the electronic apparatus 100. In this case, the remote control may receive sound via the microphone 160 and provide the received sound to the electronic apparatus 100.

The microphone 160 may include various components such as the microphone for collecting sound in an analog form, an amplifier circuit for amplifying the collected sound, an analog-to-digital (A/D) conversion circuit for sampling the amplified sound and converting the same into a digital signal, and a filter circuit for removing noise components from the converted digital signal.

Meanwhile, the microphone 160 may be implemented in the form of a sound sensor, and may be implemented using any method for collecting sound.

The processor 130 may also receive the user command through the microphone 160.

The speaker 170 may output various audio data processed by the processor 130 as well as various notification sounds and voice messages.

The processor 130 may also provide various messages to a user through the speaker 170.

The camera 180 may include a lens, a shutter, an aperture, a solid-state imaging device, an analog front end (AFE), and a timing generator (TG). The shutter may adjust time at which light reflected from a subject enters the camera 180, and the aperture may mechanically increase or decrease a size of an opening through which light enters, thereby controlling an amount of light incident on the lens. The solid-state imaging device may output the image by photoelectric charge as an electrical signal in case that light reflected by the subject is accumulated as the photoelectric charge. The TG may output a timing signal for reading out pixel data of the solid-state imaging device, and the AFE may sample and digitize the electrical signal output from the solid-state imaging device.

As described above, the electronic apparatus 100 may identify the DisplayPort version (e.g., DisplayPort 1.0, DisplayPort 1.1, DisplayPort 1.2,DisplayPort 1.3, DisplayPort 1.4, DisplayPort 2.0, or DisplayPort 2.1) of the cable and provide the guidance message based on the DisplayPort version, thereby increasing user convenience.

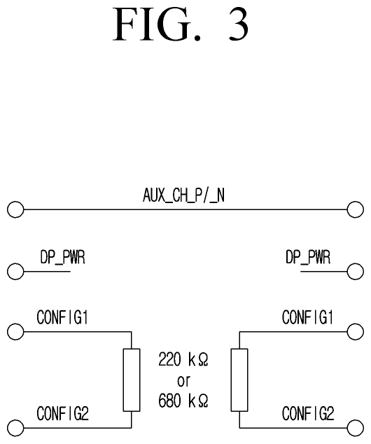

Hereinafter, the operation of the electronic apparatus 100 is described in more detail with reference to FIGS. 3 to 9. For the convenience of description, individual embodiments are described with reference to FIGS. 3 to 9. However, the individual embodiments shown in FIGS. 3 to 9 may be implemented in any combination.

FIG. 3 is a diagram for describing a structure of the cable according to an embodiment of the present disclosure.

The electronic apparatus 100 may be connected to another electronic apparatus through the cable. The cable may be a DisplayPort 2.1 standard, as shown in FIG. 3. The cable may include a power supply line DP_PWR, differential auxiliary communication channels AUX_CH_P and AUX_CH_N, and configuration pins CONFIG1 and CONFIG2, which are used in conjunction with resistors to indicate the cable type and supported bandwidth. The voltage level on the CONFIG1 pin, relative to the CONFIG2 pin, may enable the sink device and/or the source device (e.g., the electronic apparatus 100) to detect or identify the specific DisplayPort cable standard in use. The cable may include the 680 kohm resistor if the cable supports DisplayPort 2.1 DP 54, and the cable may include the 220 kohm resistor if the cable supports DisplayPort 2.1 DP 80.

For the convenience of description, FIG. 3 shows only a case where the cable includes the resistor, and is not limited thereto. For example, if the cable conforms to DisplayPort 1.4 or lower specification, the cable may be short-circuited without including a resistor at a position corresponding to the 680 kohm resistor or the 220 kohm resistor in a DisplayPort 2.1 specification.

If the cable is connected thereto, the CONFIG1 pin may be connected to the DP_PWR pin, which is pin 19 of the cable, thereby applying a voltage between the CONFIG1 pin and the CONFIG2 pin. The processor 130 may identify the voltage on the CONFIG2 pin by using a general-purpose input/output (GPIO) pin.

The processor 130 may provide the guidance message based on the communication standard supported by the cable and the performance information of the electronic apparatus 100.

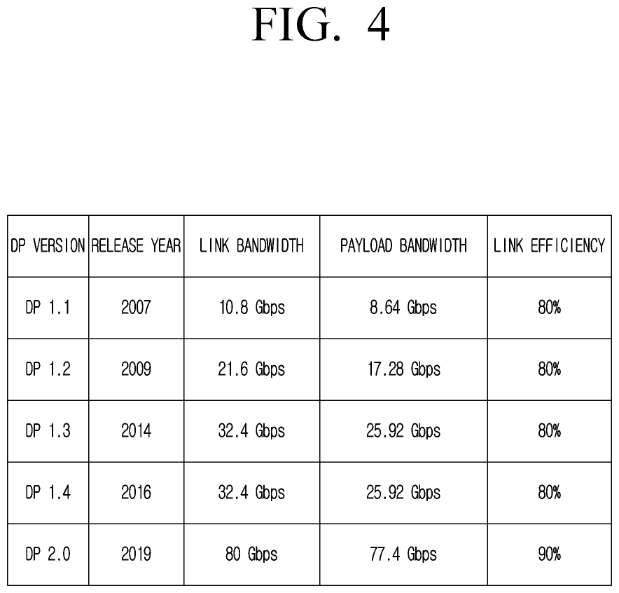

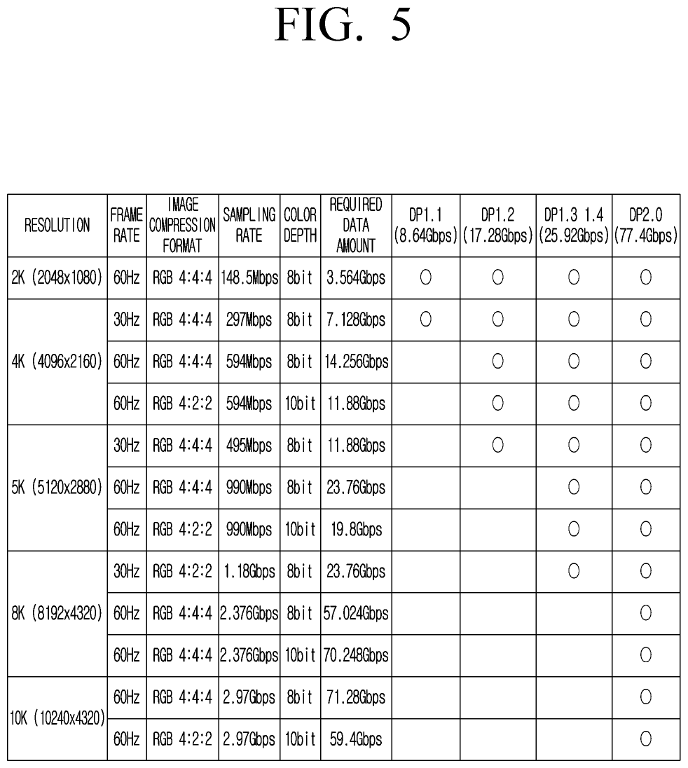

FIGS. 4 and 5 are diagrams for respectively describing the communication standard supported by the cable and performance information of the display 140 according to an embodiment of the present disclosure. FIGS. 4 and 5 show only some of the communication standard supported by the cable and some of the performance information of the display 140, and the present disclosure is not limited thereto.

The cable may conform to various specifications, as shown in FIG. 4. In addition, the display 140 may also exhibit different performance, as shown in FIG. 5.

The processor 130 may provide the guidance message by comparing the communication standard supported by the cable with the performance information of the display 140.

For example, if a DP 2.0 cable is connected to the communication interface 120, the processor 130 may identify the communication standard supported by the cable as DP 2.0 (or DP 2.1) based on the voltage applied to the first pin included in the communication interface 120. The DP 2.0 cable and the DP 2.1 cable may include the 220 kohm resistor and the 680 kohm resistor, respectively, and may have the same bandwidth. Accordingly, the processor 130 may identify the DP 2.0 cable and the DP 2.1 cable as the same cable. For the convenience of description, the processor 130 is described as identifying the DP 2.0 cable with reference to FIGS. 4 and 5.

The memory 110 may store performance for each cable communication standard and the performance information of the display 140. That is, if the communication standard supported by the cable is identified as DP 2.0, the processor 130 may identify that the bandwidth of the cable is 80 Gbps. The processor 130 may identify a required data amount of the display 140 based on the information stored in the memory 110. If the bandwidth of the cable is 80 Gigabits per second (Gbps), the processor 130 may control the display 140 to display the first guidance message because the cable has a bandwidth greater than all required data amounts shown in FIG. 5.

If a DP 1.3 cable is connected to the communication interface 120, the processor 130 may identify the communication standard supported by the cable as DP 2.0 (or DP 2.1) or a lower specification based on the voltage applied to the first pin included in the communication interface 120. In this case, the processor 130 may control the display 140 to display the second guidance message based on the required data amount of the display 140. For example, if the required data amount by the display 140 is 32.4 Gbps or more, the processor 130 may control the display 140 to display the guidance message indicating that the cable needs to be replaced. If the required data amount of the display 140 is less than 32.4 Gbps, the processor 130 may control the display 140 to display a guidance message recommending the communication standard supported by the cable based on the required data amount of the display 140. For example, if the required data amount of the display 140 is 11.88 Gbps, the processor 130 may control the display 140 to display the guidance message recommending the cable of DP 1.2 or higher.

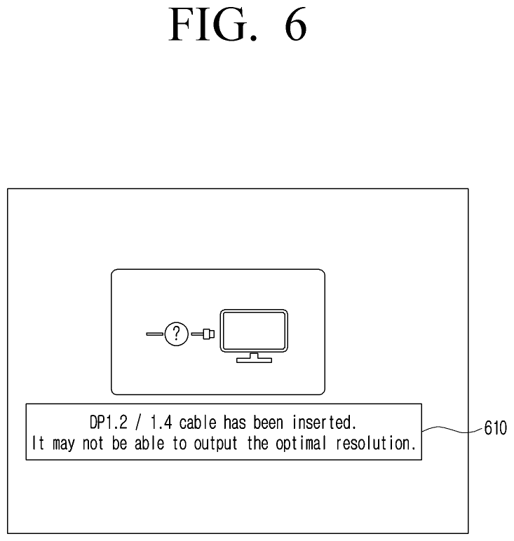

FIGS. 6 to 9 are diagrams for respectively describing a method for providing a guidance message according to an embodiment of the present disclosure.

The processor 130 may provide the second guidance message if the communication standard supported by the cable is lower than the performance of the electronic apparatus 100. For example, as shown in FIG. 6, if the resolution corresponding to the communication standard supported by the cable is lower than the resolution of the display 140, the processor 130 may provide a second guidance message 610 such as “DP 1.2/1.4 cable has been inserted. It may not be able to output the optimal resolution.”

The processor 130 may control the communication interface 120 to output the second guidance message through the speaker 170 or transmit the same to the user terminal device if the communication standard supported by the cable is less than the performance of the electronic apparatus 100.

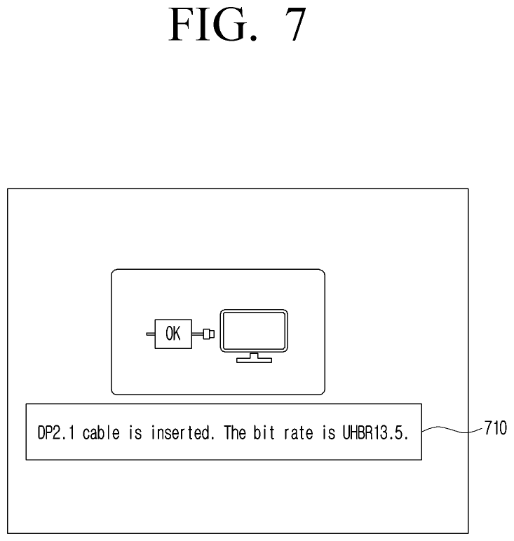

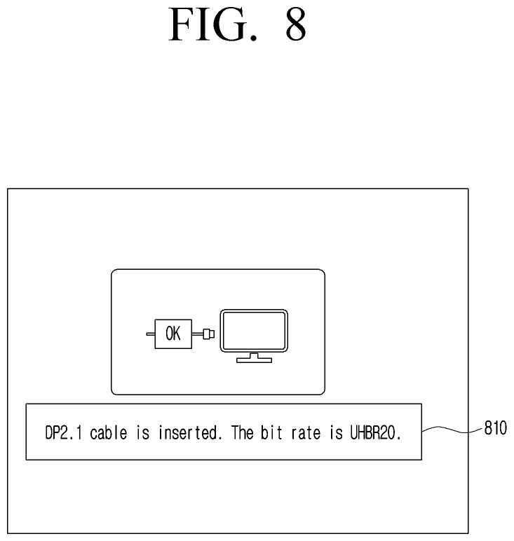

The processor 130 may provide the first guidance message if the communication standard supported by the cable is higher than or equal to the performance of the electronic apparatus 100. For example, if the bandwidth corresponding to the communication standard supported by the cable is greater than the bandwidth of the display 140, the processor 130 may provide a first guidance message 710 such as “DP 2.1 cable is inserted. The bit rate is UHBR13.5.” as in FIG. 7, or a first guidance message 810 such as “DP 2.1 cable is inserted. The bit rate is UHBR20.” as in FIG. 8.

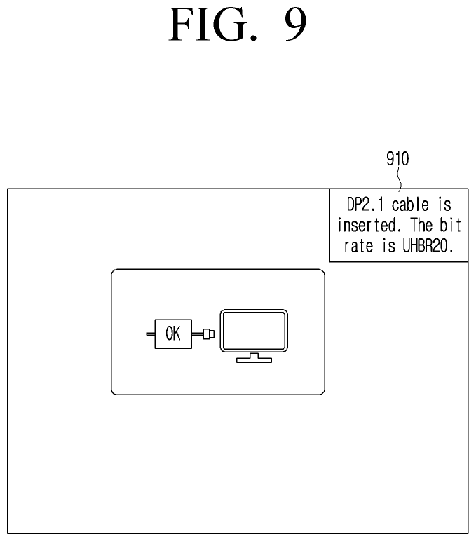

If the bandwidth corresponding to the communication standard supported by the cable is greater than the bandwidth of the display 140, the processor 130 may provide a first guidance message 810 such as “DP 2.1 cable is inserted. The bit rate is UHBR20.”on the upper right side of the display 140 as in FIG. 9.

That is, FIG. 6 shows a case of recommending the replacement of the cable. A more active notification needs to be provided to the user. However, FIGS. 7 to 9 show a case of merely informing the user that there is no problem with the cable, rather than recommending the replacement of the cable. Accordingly, the guidance message may be provided in a way that minimizes disturbance to the user, as in FIG. 9.

However, the processor 130 is not limited thereto. The processor 130 may not provide the first guidance message, or may output a short beep through the speaker 170 to minimize the disturbance to the user.

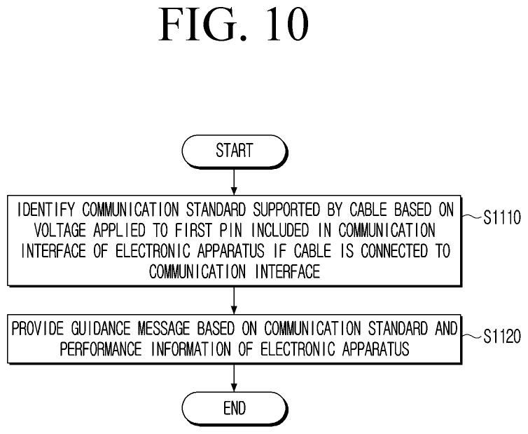

FIG. 10 is a flowchart for describing a control method of an electronic apparatus according to an embodiment of the present disclosure.

First, the method may include identifying the communication standard supported by the cable based on the voltage applied to the first pin included in the communication interface if the cable is connected to the communication interface of the electronic apparatus (operation S1110). In addition, the method may include providing the guidance message based on the communication standard and the performance information of the electronic apparatus (operation S1120).

In addition, in the providing of the guidance message (operation S1120), the guidance message may be displayed based on the communication standard and the performance information of the display included in the electronic apparatus.

In addition, in the providing of the guidance message (operation S1120), the first guidance message may be displayed if the first bandwidth supported by the communication standard is greater than or equal to the second bandwidth supported by the display, and the second guidance message may be displayed if the first bandwidth is less than the second bandwidth.

In addition, the first guidance message may include the display state information of the display, and the second guidance message may include the guidance message indicating that the cable needs to be replaced.

In addition, in the providing of the guidance message (operation S1120), the first guidance message and the second guidance message may be displayed at different positions.

In addition, the method may further include resetting at least one of the extended display identification data (EDID) or DisplayPort configuration data (DPCD) of the display based on the cable.

In addition, the method may further include transmitting the guidance message to the user terminal device if the first bandwidth supported by the communication standard is less than the second bandwidth supported by the display.

In addition, the performance information of the display may include at least one of the bandwidth or resolution of the display.

In addition, the method may further include displaying the guidance message based on the communication standard and the changed performance information of the display if the user command for changing at least one of the bandwidth or resolution of the display is received.

In addition, in the identifying of the communication standard (operation S1110), the cable may be identified as the cable conforming to the first communication standard if the voltage applied to the first pin is 0 V, the cable may be identified as the cable conforming to the second communication standard if the voltage applied to the first pin exceeds 0 V and falls within the first voltage range, and the cable may be identified as the cable conforming to the third communication standard if the voltage applied to the first pin exceeds 0 V and falls within the second voltage range greater than the first voltage range.

In addition, in the providing of the guidance message (operation S1120), the guidance message may be output through the speaker included in the electronic apparatus based on the communication standard and the performance information of the electronic apparatus.

According to the various embodiments of the present disclosure, the electronic apparatus may improve the user convenience by identifying the DisplayPort version of the cable and providing the guidance message based on the identified DisplayPort version.

Meanwhile, according to one or more embodiments of the present disclosure, the various embodiments described above may be implemented by software including an instruction stored in a machine-readable storage medium (for example, a computer-readable storage medium). The machine may be a device that invokes the stored instruction from a storage medium, may be operated based on the invoked instruction, and may include the electronic apparatus (e.g., electronic apparatus A) according to the disclosed embodiments. In case that the instruction is executed by the processor, the processor may directly perform a function corresponding to the instruction, or other components may perform the function corresponding to the instruction under a control of the processor. The instruction may include codes provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

In addition, according to an embodiment of the present disclosure, the method according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™. In case of the online distribution, at least a portion of the computer program product may be at least temporarily stored or temporarily generated on a storage medium such as the memory of a manufacturer server, an application store server, or a relay server.

In addition, according to an embodiment of the present disclosure, the various embodiments described above may be implemented in a computer-readable recording medium or a device similar thereto that uses software, hardware, or a combination of software and hardware. In some cases, the embodiments described in the specification may be implemented by a processor itself. According to software implementation, the embodiments such as the procedures and functions described in the specification may be implemented by separate software modules. Each of the software modules may perform at least one function or operation described in the specification.

Meanwhile, computer instructions for performing processing operations of the device according to the various embodiment of the present disclosure described above may be stored in a non-transitory computer-readable medium. The computer instructions stored in the non-transitory computer-readable medium may allow a specific device to perform the processing operations of the device according to the various embodiments described above in case that the computer instructions are executed by a processor of the specific device. The non-transitory computer-readable medium is not a medium that temporarily stores data, such as a register, a cache, or a memory, and indicates a medium that semi-permanently stores data and is readable by the device. A specific example of the non-transitory computer-readable medium may include a compact disk (CD), a digital versatile disk (DVD), a hard disk, a Blu-ray disk, a universal serial bus (USB), a memory card, a read-only memory (ROM), or the like.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs or other components according to the various embodiments may be executed in a sequential manner, a parallel manner, an iterative manner or a heuristic manner, and at least some of the operations may be performed in a different order, omitted, or supplemented with other operations.

Although the embodiments of the present disclosure have been shown and described hereinabove, the present disclosure is not limited to the above-mentioned specific embodiments, and may be variously modified by those skilled in the art to which the present disclosure pertains without departing from the scope and spirit of the present disclosure as disclosed in the accompanying claims. These modifications should also be understood to fall within the scope and spirit of the present disclosure.

What is claimed is:

1. An electronic apparatus comprising:
a memory storing instructions;
a communication interface; and
at least one processor including processing circuitry,
wherein when individually or collectively executed by the at least one processor, the instructions cause the at least one processor to based on a video interface cable being connected to the communication interface, identify a communication standard supported by the video interface cable based on a voltage applied to a configuration pin included in the communication interface, and
provide a guidance message based on the communication standard and display capability information of the electronic apparatus.

2. The apparatus as claimed in claim 1, further comprising a display,
wherein when individually or collectively executed by the at least one processor, the instructions cause the at least one processor to
control the display to display the guidance message based on the communication standard and the display capability information of the display.

3. The apparatus as claimed in claim 2, wherein when individually or collectively executed by the at least one processor, the instructions cause the at least one processor to
based on a first bandwidth supported by the communication standard being greater than or equal to a second bandwidth supported by the display, control the display to display a first guidance message, and
based on the first bandwidth being less than the second bandwidth, control the display to display a second guidance message.

4. The apparatus as claimed in claim 3, wherein the first guidance message comprises display state information of the display, and
the second guidance message suggests a replacement of the video interface cable.

5. The apparatus as claimed in claim 3, wherein when individually or collectively executed by the at least one processor, the instructions cause the at least one processor to
control the display to display the first guidance message and the second guidance message at different positions.

6. The apparatus as claimed in claim 2, wherein when individually or collectively executed by the at least one processor, the instructions cause the at least one processor to
reset at least one of extended display identification data (EDID) or DisplayPort configuration data (DPCD) of the display based on the video interface cable.

7. The apparatus as claimed in claim 2, wherein when individually or collectively executed by the at least one processor, the instructions cause the at least one processor to
based on a first bandwidth supported by the communication standard being less than a second bandwidth supported by the display, control the communication interface to transmit the guidance message to a user terminal device.

8. The apparatus as claimed in claim 2, wherein the display capability information of the display comprises at least one of a bandwidth or a resolution of the display.

9. The apparatus as claimed in claim 2, further comprising a user interface,
wherein when individually or collectively executed by the at least one processor, the instructions cause the at least one processor to
based on a user command for changing at least one of a bandwidth or a resolution of the display being received,
control the display to display the guidance message based on the communication standard and the changed at least one of the bandwidth or the resolution of the display.

10. The apparatus as claimed in claim 1, wherein when individually or collectively executed by the at least one processor, the instructions cause the at least one processor to
based on the voltage applied to the configuration pin being 0 V, identify the video interface cable as conforming to a first communication standard,
based on the voltage applied to the configuration pin exceeding 0 V and being within a first voltage range, identify the video interface cable as conforming to a second communication standard, and
based on the voltage applied to the configuration pin exceeding 0 V and being within a second voltage range greater than the first voltage range, identify the video interface cable as conforming to a third communication standard.

11. The apparatus as claimed in claim 1, further comprising a speaker,
wherein when individually or collectively executed by the at least one processor, the instructions cause the at least one processor to
output the guidance message through the speaker based on the communication standard and the display capability information of the electronic apparatus.

12. A control method of an electronic apparatus, the control method comprising:
based on a video interface cable being connected to a communication interface:
identifying a communication standard supported by the video interface cable based on a voltage applied to a configuration pin included in the communication interface of the electronic apparatus; and
providing a guidance message based on the communication standard and display capability information of the electronic apparatus.

13. The control method as claimed in claim 12, wherein in the providing of the guidance message,
displaying the guidance message based on the communication standard and the display capability information of a display included in the electronic apparatus.

14. The control method as claimed in claim 13, wherein in the providing of the guidance message,
based on a first bandwidth supported by the communication standard being greater than or equal to a second bandwidth supported by the display, displaying a first guidance message, and
based on the first bandwidth being less than the second bandwidth, displaying a second guidance message.

15. The control method as claimed in claim 14, wherein the first guidance message includes display state information of the display, and
the second guidance message suggests a replacement of the video interface cable.

16. A non-transitory computer-readable storage medium storing instructions that, when executed by one or more processors, cause the one or more processor to perform:
based on a video interface cable being connected between a source device and a sink device through a communication interface, identifying a communication standard supported by the video interface cable based on a voltage applied to a configuration pin in the communication interface; and
providing a guidance message based on the identified communication standard and display capability information of the sink device.
